(19) United States
(12) Patent Application Publication
(10) Pub. No.: US 2016/0044674 A1
(43) Pub. Date: Feb. 11, 2016

(54) SELECTABLE CONFIGURATION FOR UPLINK ACKNOWLEDGEMENT RESOURCES

(71) Applicant: Sony Corporation, Tokyo (JP)

(72) Inventor: Na Wei, Beijing (CN)

(21) Appl. No.: 14/511,836

(22) Filed: Oct. 10, 2014

Related U.S. Application Data
(63) Continuation of application No. PCT/CN2014/083990, filed on Aug. 8, 2014.

(51) Int. Cl. H04W 72/04

(52) U.S. Cl. CPC H04W 72/0453

(57) ABSTRACT

A carrier (21) is configured for communication between a communication device (100) and a cellular network. A configuration of the carrier (21) is selected. The configuration defines radio resources which are reserved for transmission of acknowledgements concerning uplink transmissions from the communication device (100) to the cellular network. Further, a selection between a first subconfiguration and a second subconfiguration is performed. In the first subconfiguration the reserved radio resources are configured for said transmission of acknowledgements concerning uplink transmissions. In the second subconfiguration the reserved radio resources are not configured for said transmission of acknowledgements concerning uplink transmissions.

### FIELD OF THE INVENTION

The present invention relates to methods of controlling communication in a cellular network and to corresponding devices.

### BACKGROUND OF THE INVENTION

The LTE (Long Term Evolution) technology specified by 3GPP (3^{rd} generation partnership project), provides a mechanism referred to as carrier aggregation. In carrier aggregation multiple carriers from different parts of the frequency spectrum may be combined to serve a communication device, in the following also referred to as user equipment (UE), connected to a cell of the cellular network. In typical scenarios, a first pair of primary carriers is used to establish a primary cell (PCell) and further carriers may be used to establish one or more secondary cells (SCells) to provide increased data transmission performance to the UE. As a general rule, the PCell is formed by carriers from a licensed frequency band, which is exclusively assigned to the cellular network. While the also the SCell(s) may be formed in a licensed frequency band, it is also proposed to utilize an unlicensed frequency band for the SCell(s). Corresponding proposals are for example discussed in 3GPP meeting contribution RP-140786, “Motivation of the New SI Proposal: Study on Licensed-Assisted Access using LTE”, Huawei, Ericsson, Qualcomm, HiSilicon, Disc REL-13, TSG-RAN #64, 10-13 Jun. 2014, Sophia Antipolis, France, and in 3GPP meeting contribution RP-140770, “New SI proposal: Study on Licensed-Assisted Access using LTE”, Ericsson, Qualcomm, Huawei, TSG-RAN #64, 10-13 Jun. 2014, Sophia Antipolis, France.

Further, the LTE technology provides a FDD (Frequency Division Duplex) mode and a TDD (Time Division Duplex) mode. In the FDD mode, transmissions in a downlink (DL) direction are performed on one or more carriers which are different from one or more carriers on which transmissions in the uplink (UL) direction are performed. In the TDD mode, transmissions in the DL direction and in the UL direction may be performed on the same carrier, in different time slots, also referred to as subframes. Here, the DL direction refers to a transmission direction from the cellular network to the UE. The UL direction refers to a transmission direction from the communication device to the cellular network.

Radio frame structures for the FDD mode and for the TDD of the LTE technology are for example defined in 3GPP TS 36.211 V12.2.0 (2014-06). In the case of the radio frame structure for the TDD mode, also referred to as frame structure type 2, different UL-DL configurations concerning the assignment of the subframes to the DL direction and the UL direction are possible. As a general rule, the subframes may be either assigned to the DL direction, to the UL direction, or as “special” subframes. One extreme case specified in Table 4.2-2 of 3GPP TS 36.211 V12.2.0 is a DL heavy 0:8 UL-DL configuration, referred to as “configuration #5” in which two subframes are assigned to the UL direction and eight subframes are assigned to the DL direction.

In 3GPP meeting contribution RP-140710, “Proposal for a configuration for Supplemental Downlink for TD-LTE”, NTT DOCOMO, INC., 3GPP TSG-RAN #64, 10-13 Jun. 2014, Sophia Antipolis, France, a further UL-DL configuration, referred to as “configuration #7” is proposed, in which all subframes of the radio frame are assigned to the DL direction. A correspondingly configured TDD carrier may for example be used in carrier aggregation scenarios for an SCell when the PCell is operated in FDD mode.

In 3GPP meeting contribution RP-140762, “Introduction of supplemental downlink for TD-LTE, CR 36.211”, NTT DOCOMO, INC., 3GPP TSG-RAN #64, 10-13 Jun. 2014, Sophia Antipolis, France, is further proposed to apply the configuration of the PHICH (Physical Hybrid ARQ Indicator Channel) as defined for configuration #5 also to configuration #7. The PHICH is utilized for transmission of positive acknowledgements (ACKs) and negative acknowledgements (NACKs) with respect to UL transmissions and is transmitted in the first OFDM (Orthogonal Frequency Division Multiplexing) symbols of certain subframes of the radio frame.

However, the above way of handling the PHICH may imply inefficient usage of radio resources. For example, if the TDD carrier is utilized in configuration #7, there might be no UL transmissions and thus no need for transmission of ACK/NACK feedback on the PHICH, which means that the radio resources allocated to the PHICH would be wasted. On the other hand, the PHICH may for example be needed when the TDD carrier in configuration #7 is used in a carrier aggregation scenario and paired with an UL FDD carrier.

Resource usage with respect to the PHICH may also be inefficient in other scenarios, e.g., if a DL FDD carrier on which the PHICH is transmitted is paired with an UL FDD carrier from an unlicensed spectrum, UL transmissions on the UL carrier are temporarily deactivated.

Accordingly, there is a need for techniques which allow for efficiently controlling utilization of resources for transmission of acknowledgements concerning UL transmissions.

### SUMMARY OF THE INVENTION

According to an embodiment of the invention, a method of controlling communication in a cellular network is provided. According to the method, a communication device configures a carrier for communication with the cellular network. This involves that the communication device selects a configuration of the carrier. The configuration defines radio resources which are reserved for transmission of acknowledgements concerning UL transmissions from the communication device to the cellular network. Further, the communication device selects between a first subconfiguration and a second subconfiguration. In the first subconfiguration the reserved radio resources are configured for said transmission of acknowledgements concerning UL transmissions. In the second subconfiguration the reserved radio resources are not configured for said transmission of acknowledgements concerning UL transmissions. If the cellular network is based on the LTE technology, the reserved radio resources may be radio resources of a PHICH.

The carrier may be utilized in carrier aggregation scenarios, in which further carriers are configured for UL and/or DL communication between the communication device and the cellular network. According to an embodiment, the UL transmissions to which the above-mentioned acknowledgements relate may be on a further carrier, which is different from the aforementioned carrier. Such further carrier may be a FDD carrier and may be located in a different frequency spectrum. In some scenarios, the further carrier may be located in an unlicensed frequency band. The carrier and the further carrier may be paired to provide a secondary cell (SCell) of a carrier aggregation constellation with multiple DL and UL carriers. In such SCell, the carrier may be a TDD carrier which is utilized for DL transmissions and configured with all subframes assigned to the DL transmission direction, while the further carrier is an UL FDD carrier.

According to an embodiment, the selection between the first subconfiguration and the second subconfiguration may be performed depending on activation or deactivation of the UL transmissions on the further carrier. For example, the further carrier on which the UL transmissions are performed may be temporarily deactivated, e.g., due to interference. The further carrier may also be deactivated with the purpose of vacating its frequency spectrum for other usage. Such temporary deactivation may for example be needed if the frequency spectrum of the carrier is from an unlicensed frequency band and not exclusively assigned to the cellular network. In response to the UL transmissions on the further carrier being de-activated, which means that there is no need for transmission of the acknowledgements, the communication device may select the second subconfiguration. In response to the UL transmissions on the further carrier being activated, the communication device may select the first subconfiguration to enable the transmission of the acknowledgements.

According to an embodiment, the carrier is configured as a TDD carrier. Transmission on the carrier is organized in radio frames which are each subdivided into subframes, and the configuration defines one or more of the subframes of the radio frame which are assigned to a DL direction from the cellular network to the communication device and/or one or more of the subframes of the radio frame which are assigned to a UL direction from the communication device to the cellular network. In some scenarios, all subframes of the radio frame may be assigned to the DL direction. This may trigger selection of the second subconfiguration. Accordingly, the communication device may select the second subconfiguration in response to the carrier being configured as a TDD carrier with all subframes of the radio frame assigned to the DL direction.

According to an embodiment, the communication device receives control information from the cellular network and selects the second subconfiguration depending on this control information. For example, the control information may explicitly indicate that the second subconfiguration shall be used, e.g., by providing a corresponding information element in DL control signaling from the cellular network. Further, the control information may implicitly indicate that the second subconfiguration shall be used. For example, the control information may indicate deactivation of the further carrier on which the UL transmissions are performed, and this may implicitly indicate that the second subconfiguration shall be used. As another example, the control information may indicate that the configuration of the carrier as a TDD carrier with all subframes assigned to the DL direction, and this may implicitly indicate that the second subconfiguration shall be used.

Various kinds of signaling may be utilized to convey the control information. For example, in the LTE technology, the control information could be broadcast in a MIB (Master Information Block) or in a SIB (System Information Block). Still further, a RRC (Radio Resource Control) message or L2/L1 (layer 2/layer 1) signaling could be utilized for conveying the control information to the communication device.

According to a further embodiment of the invention, a method of controlling communication in a cellular network is provided. According to the method, a node of the cellular network, e.g., a base station, configures a carrier for communication with a communication device. This involves that the node selects a configuration of the carrier. The configuration defines radio resources which are reserved for transmission of acknowledgements concerning UL transmissions from the communication device to the cellular network. Further, the communication device selects between a first subconfiguration and a second subconfiguration. In the first subconfiguration the reserved radio resources are configured for said transmission of acknowledgements concerning UL transmissions. In the second subconfiguration the reserved radio resources are not configured for said transmission of acknowledgements concerning UL transmissions. If the cellular network is based on the LTE technology, the reserved radio resources may be radio resources of a PHICH.

The carrier may be utilized in carrier aggregation scenarios, in which further carriers are configured for UL and/or DL communication between the communication device and the cellular network. According to an embodiment, the UL transmissions to which the above-mentioned acknowledgements relate may be on a further carrier, which is different from the aforementioned carrier. Such further carrier may be a FDD carrier and may be located in a different frequency spectrum. In some scenarios, the further carrier may be located in an unlicensed frequency band. The carrier and the further carrier may be paired to provide a secondary cell (SCell) of a carrier aggregation constellation with multiple DL and UL carriers. In such SCell, the carrier may be a TDD carrier which is utilized for DL transmissions and configured with all subframes assigned to the DL transmission direction, while the further carrier is an UL FDD carrier.

According to an embodiment, the selection between the first subconfiguration and the second subconfiguration may be performed depending on activation or deactivation of the UL transmissions on the further carrier. For example, the further carrier on which the UL transmissions are performed may be temporarily deactivated, e.g., due to interference. The further carrier may also be deactivated with the purpose of vacating its frequency spectrum for other usage. Such temporary deactivation may for example be needed if the frequency spectrum of the carrier is from an unlicensed frequency band and not exclusively assigned to the cellular network. In response to the UL transmissions on the further carrier being de-activated, which means that there is no need for transmission of the acknowledgements, the node may select the second subconfiguration. In response to the UL transmissions on the further carrier being activated, the node may select the first subconfiguration to enable the transmission of the acknowledgements.

According to an embodiment, the carrier is configured as a TDD carrier. Transmission on the carrier is organized in radio frames which are each subdivided into subframes, and the configuration defines one or more of the subframes of the radio frame which are assigned to a DL direction from the cellular network to the communication device and/or one or more of the subframes of the radio frame which are assigned to a UL direction from the communication device to the cellular network. In some scenarios, all subframes of the radio frame may be assigned to the DL direction. This may trigger selection of the second subconfiguration. Accordingly, the node may select the second subconfiguration in response to the carrier being configured as a TDD carrier with all subframes of the radio frame assigned to the DL direction.

According to an embodiment, the node sends control information to the communication device. The control information may explicitly or implicitly indicate the selected subconfiguration. For example, the control information may explicitly indicate that the second subconfiguration shall be used, e.g., by providing a corresponding information element in DL control signaling from the cellular network. Further, the control information may implicitly indicate that the second subconfiguration shall be used. For example, the control information may indicate deactivation of the further carrier on which the UL transmissions are performed, and this may implicitly indicate that the second subconfiguration shall be used. As another example, the control information may indicate that the configuration of the carrier as a TDD carrier with all subframes assigned to the DL direction, and this may implicitly indicate that the second subconfiguration shall be used.

Various kinds of signaling may be utilized to convey the control information. For example, in the LTE technology, the control information could be broadcast in an MIB or in an SIB. Still further, an RRC message or L2/L1 signaling could be utilized for conveying the control information to the communication device.

According to a further embodiment of the invention, a communication device is provided. The communication device comprises a radio interface for connecting to a cellular network. Further, the communication device comprises a processor. The processor is configured to configure a carrier for communication with the cellular network. In this connection, the processor is also configured to select a configuration of the carrier. The configuration defines radio resources which are reserved for transmission of acknowledgements concerning UL transmissions from the communication device to the cellular network. Further, the processor is configured to select between a first subconfiguration and a second subconfiguration. In the first subconfiguration the reserved radio resources are configured for said transmission of acknowledgements concerning UL transmissions. In the second subconfiguration the reserved radio resources are not configured for said transmission of acknowledgements concerning UL transmissions. If the cellular network is based on the LTE technology, the reserved radio resources may be radio resources of a PHICH.

The processor may be configured to perform the above-mentioned method steps performed by the communication device.

According to a further embodiment of the invention, a node for a cellular network is provided. For example, the node may be a base station, such as an eNB (“evolved Node B”) of the LTE technology. The node comprises a radio interface for connecting to a communication device. Further, the node comprises a processor. The processor is configured to configure a carrier for communication with the communication device. In this connection, the processor is also configured to select a configuration of the carrier. The configuration defines radio resources which are reserved for transmission of acknowledgements concerning UL transmissions from the communication device to the cellular network. Further, the processor is configured to select between a first subconfiguration and a second subconfiguration. In the first subconfiguration the reserved radio resources are configured for said transmission of acknowledgements concerning UL transmissions. In the second subconfiguration the reserved radio resources are not configured for said transmission of acknowledgements concerning UL transmissions. If the cellular network is based on the LTE technology, the reserved radio resources may be radio resources of a PHICH.

The processor may be configured to perform the above-mentioned method steps performed by the cellular network node.

According to an embodiment of the above methods, communication device, or node, in the second subconfiguration the reserved radio resources are configured for transmission of other data than acknowledgements concerning UL transmissions from the communication device to the cellular network. Such other data may for example comprise control information from the cellular network. The control information may indicate activation or deactivation of transmission on the carrier in an upcoming time period.

According to an embodiment, the cellular network may utilize a small cell deployment, i.e., comprise at least one macro cell and multiple small cells located within a coverage region of the macro cell. In such scenarios, the control information transmitted on the certain radio resources may indicate whether or not a coverage region of the small cell which serves the communication on the carrier has overlap with a coverage region of one or more others of the small cells, e.g., by distinguishing between a dense and a sparse small cell deployment.

The above and further embodiments of the invention will now be described in more detail with reference to the accompanying drawings.

### BRIEF DESCRIPTION OF THE DRAWINGS

FIG. 1 schematically illustrates an exemplary scenario of cellular network communication according to an embodiment of the invention.

FIG. 2 schematically illustrates organization of transmission on a carrier according to an embodiment of the invention.

FIG. 3 schematically illustrates carrier aggregation with carriers from an unlicensed subband as utilized according to an embodiment of the invention.

FIG. 4 shows an exemplary carrier aggregation scenario in which activation or deactivation of a paired UL carrier may be used for selecting a configuration of the paired DL carrier.

FIG. 5 schematically illustrates a small cell deployment which may be utilized according to an embodiment of the invention.

FIG. 6 shows a further exemplary carrier aggregation scenario in which radio resources of a DL carrier may be utilized for controlling activation or deactivation of transmission on the DL carrier.

FIG. 7 shows exemplary UL-DL configurations of a TDD carrier which may be utilized according to an embodiment of the invention.

FIG. 8 shows exemplary configurations of a PHICH which may be utilized according to an embodiment of the invention.

FIG. 9 shows a flowchart for illustrating a method according to an embodiment of the invention.

FIG. 10 shows a flowchart for illustrating a further method according to an embodiment of the invention.

FIG. 11 schematically illustrates structures of a communication device according to an embodiment of the invention.

FIG. 12 schematically illustrates structures of a cellular network node according to an embodiment of the invention.

### DETAILED DESCRIPTION OF EMBODIMENTS

In the following, concepts according to exemplary embodiments of the invention will be described in more detail. It has to be understood that the following description is given only for the purpose of illustrating the principles of the invention and is not to be taken in a limiting sense. Rather, the scope of the invention is defined only by the appended claims and is not intended to be limited by the exemplary embodiments described hereinafter.

The illustrated embodiments relate to control of communication in a cellular network. In the illustrated embodiments, the cellular network is assumed to be based on the LTE technology. However, it is to be understood that the illustrated concepts could be applied to other technologies as well.

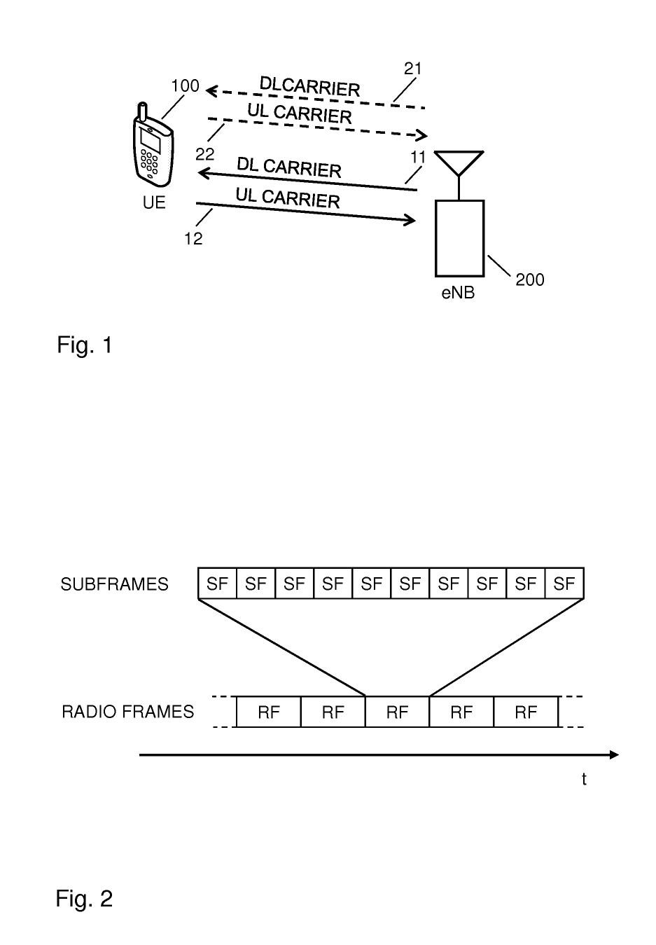

FIG. 1 schematically illustrates a communication device 100, in the following referred to as user equipment (UE), which is connected to a cellular network. More specifically, the UE 100 is connected to a base station 200 of the cellular network. In accordance with the illustrated LTE scenario, the base station 200 is also referred to as eNB. The UE 100 may for example be a mobile phone, a portable computer, or some other communication device with cellular network connectivity.

As illustrated, communication between the UE 100 and the eNB 200 may utilize various carriers 11, 12, 21, 22, in the illustrated scenario, a DL carrier 11, a UL carrier 12, and a further DL carrier 21, and a further UL carrier 22. In some scenarios the DL carrier 11, the UL carrier 12, the further DL carrier 21, and the further UL carrier 22 may be used in combination in a carrier aggregation constellation. The further DL carrier 21 and the further UL carrier 22 may for example be activated and configured on demand if it is desired to provide increased data communication performance to the UE 100. The DL carrier 11, the UL carrier 12, the further DL carrier 21, and the further UL carrier 22 may be located in different parts of the frequency spectrum. For example, the DL carrier 11 and the UL carrier 12 may be located in a licensed frequency band, which is exclusively assigned to the cellular network. The further DL carrier 21 and the further UL carrier 22 may in turn be located in an unlicensed frequency band, which is not exclusively assigned to the cellular network and may additionally be utilized by other radio technologies. As will be further explained below, the further DL carrier 21 may be used in various configurations. Such configurations may correspond to an FDD configuration or a TDD configuration.

In an FDD configuration, transmissions in a DL direction from the cellular network to the UE 100 are performed on frequency resources which are different from frequency resources on which transmissions in a UL direction from the UE 100 to the cellular network are performed. As compared to that, in a TDD configuration the same frequency resources may be utilized for transmissions both in the DL direction and the UL direction. However, in a TDD configuration, transmissions in the DL direction are performed in different time slots than transmissions in the UL direction.

The time-domain organization of transmissions between the UE 100 and the cellular network is further illustrated in FIG. 2.

As illustrated, the transmission may be organized in a sequence of radio frames RF, which are each subdivided into multiple subframes SF. In accordance with the illustrated LTE scenario, the duration of each radio frame may be 10s, and there may be ten subframes SF in each radio frame RF. In a TDD configuration of the carrier, one or more of the subframes SF of the radio frame RF may be assigned to the DL direction, and/or one or more of the subframes of the radio frame RF may be assigned to the UL direction, thereby enabling DL and UL transmissions of the same frequency resources.

The communication between the UE 100 and the cellular network is assumed to be based on a HARQ (Hybrid Automatic Repeat Request) protocol which requires sending of acknowledgements for UL transmissions from the UE 100 to the cellular network. More specifically, the cellular network may positively acknowledge a successful UL transmission from the UE 100 to the cellular network, by sending an ACK (positive acknowledgement) indication to the UE 100, or may negatively acknowledge an unsuccessful UL transmission from the UE 100 to the cellular network, by sending a NACK (negative acknowledgement) indication to the UE 100. The HARQ procedures may for example be implemented as described in 3GPP TS 36.213 V12.2.0.

For sending the HARQ acknowledgements from the cellular network to the UE 100, the LTE technology uses a PHICH from the cellular network to the UE 100. The PHICH is transmitted on certain radio resources of a subframe SF. In an FDD configuration of the carrier, radio resources for transmission of the PHICH are reserved in the first (1-3) symbols of each subframe SF. In a TDD configuration, radio resources for transmission of the PHICH are reserved in one or more of the subframes SF assigned to the DL direction.

In the embodiments as illustrated herein, it is further considered that the PHICH may not be needed in certain situations, which means that the radio resources which are reserved for transmission of the PHICH may be efficiently reused for other purposes. This is achieved by providing a first subconfiguration, in which the reserved radio resources are configured for the transmission of the PHICH, and a second subconfiguration in which the reserved radio resources are not configured for the transmission of the PHICH, but may be configured for transmission of other data.

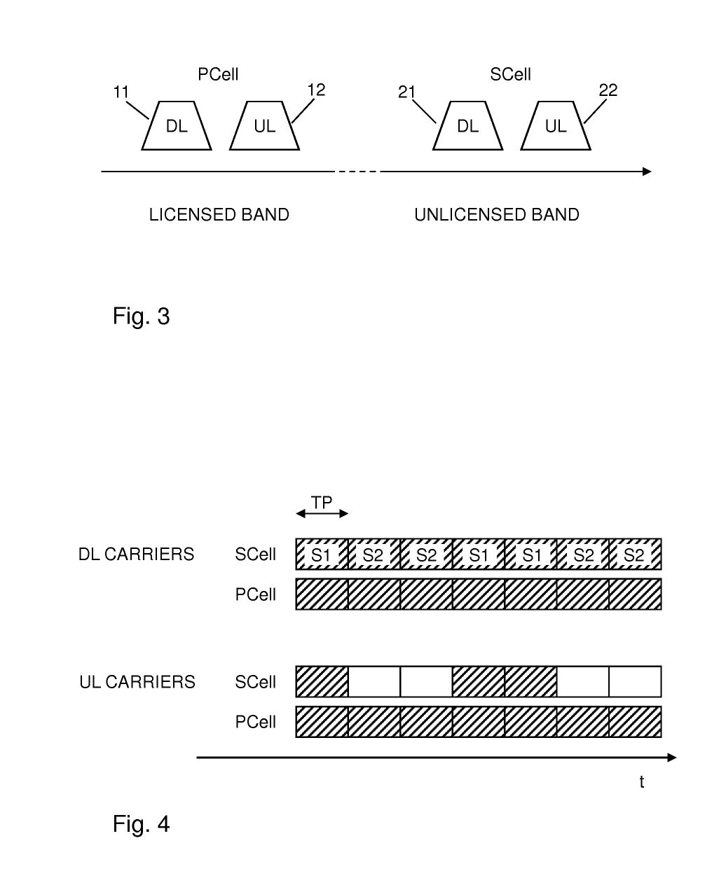

In some scenarios, the UE 100 may dynamically switch between the first and second subconfiguration, depending on whether or not there is UL transmission activity requiring transmission of the PHICH. This may for example be the case if the DL carrier 21 is paired with the UL carrier 22, which is from an unlicensed frequency band, and the UL carrier 22 is temporarily deactivated. A corresponding carrier aggregation constellation is illustrated in FIG. 3.

As shown in FIG. 3, the carrier aggregation constellation is based on a first DL carrier 11 and a first UL carrier 12 which form a primary cell (PCell), and a second DL carrier 21 and a second UL carrier 22, which form a secondary cell (SCell). The first DL carrier 11 and the first UL carrier 12 may be configured as FDD carriers. Also the second DL carrier 21 and the second UL carrier 22 may be configured as FDD carriers. However, the second DL carrier 21 could also be configured as a TDD carrier with all subframes SF assigned to the DL direction.

As further illustrated, while the first DL carrier 11 and the first UL carrier 12 may be located in a licensed frequency band, the second DL carrier 21 and the second UL carrier may be located in an unlicensed frequency band and therefore subject to interference due to other usage of the unlicensed frequency band. In addition, the part of the unlicensed frequency band occupied by the second DL carrier 21 or the second UL carrier 22 may need to be vacated in certain scenarios, e.g., when activity of a licensed user of the unlicensed frequency band is detected. Such situations may be addressed by temporarily deactivating the second UL carrier 22.

In FIG. 4 this deactivation of the second UL carrier 22 is indicated by time periods (TP) with open boxes, whereas time periods TP in which the second UL carrier 22 is active are illustrated by shaded boxes. The configuration of the second DL carrier 21 concerning the transmission of the PHICH is indicated by “S1” for the first subconfiguration and “S2” for the second subconfiguration. As can be seen, in time periods TP in which the second UL carrier 22 is deactivated, the second subconfiguration is applied. This may be accomplished without requiring explicit control signaling, in response to receiving a command for deactivation of the second UL carrier 22. The selection of the second subconfiguration allows for flexible reuse of the radio resources reserved for the PHICH. The granularity of such time periods TP may be one or more subframes SF.

In the second subconfiguration, the radio resources reserved for the PHICH may be reused for transmission of other data. For example, such other data may include control information from the cellular network. The PHICH format as for example specified in 3GPP TS 36.211 V12.2.0 may be reused for the transmission of such other data.

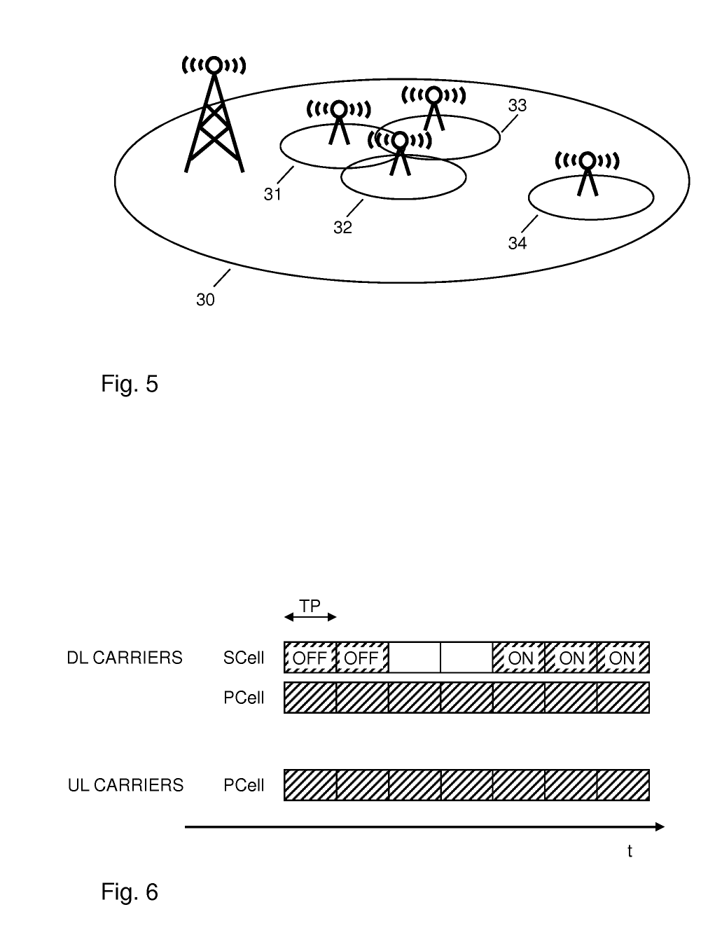

In an exemplary scenario, the control information transmitted on the PHICH resources may indicate whether the second DL carrier 21 is transmitted by a small cell in a dense or in sparse small cell deployment. An exemplary small cell deployment is illustrated in FIG. 5.

In FIG. 5, a macro cell 30 of the cellular network includes several small cells 31, 32, 33, 34. In this way, coverage and/or performance may be optimized. The small cells 31, 32, 33, 34 are located within a coverage region of the macro cell 30. DL transmissions in each of the small cells 31, 32, 33, 34 may be served by a corresponding DL carrier, such as the DL carrier 21.

As illustrated, some of the small cells 31, 32, 33 have a coverage region which overlaps a coverage region of one or more neighboring small cells 31, 32, 33. Such small cells 31, 32, 33 may be regarded as being in a dense small cell deployment. In a dense small cell deployment, the neighboring small cells 31, 32, 33 are potential candidates for a direct handover of a UE. For example, when assuming that the UE 100 is served by the small cell 31 on the second DL carrier 21, it could be directly handed over to the small cell 32 or 33. As compared to that, in a sparse small cell deployment, there is no neighboring small cell with overlapping coverage region, such as illustrated for the small cell 34. When assuming that the UE 100 is served by the small cell 34, a direct handover to one of the small cells 31, 32, 33 is not possible.

Information concerning whether the UE 100 is being served in a dense or a sparse small cell deployment can be indicated in the radio resources reserved for the PHICH. The UE 100 may utilize such information for efficiently managing handover related procedures, e.g., channel quality measurements.

The control information transmitted on the PHICH resources may also indicate activation or deactivation of transmission on the second DL carrier 21 in an upcoming time interval. A corresponding scenario is illustrated in FIG. 6. The scenario of FIG. 6 is based on a PCell configured on a DL carrier and a UL carrier (e.g., corresponding to the carriers 11, 12 of FIG. 1 or 3), and on an SCell configured on the second DL carrier 21, which may be configured as an FDD carrier or as a TDD carrier with all subframes SF assigned to the DL direction. In the scenario of FIG. 6, it is assumed that the second DL carrier 21 is not paired with an UL carrier, so that transmission of the PHICH is not required and the second subconfiguration may be selected in all subframes SF. The selection of the second subconfiguration may implicitly depend on the configured carrier aggregation constellation.

As mentioned above, the second DL carrier 21 may for example be located in an unlicensed frequency band and therefore subject to interference due to other usage of the unlicensed frequency band. In addition, the part of the unlicensed frequency band occupied by the second DL carrier 21 may need to be vacated in certain scenarios, e.g., when activity of a licensed user of the unlicensed frequency band is detected. Such situations may be addressed by temporarily deactivating the second DL carrier 21. In FIG. 6 this deactivation is indicated by time periods TP with open boxes, whereas time periods TP in which the further second DL carrier 21 is active are illustrated by shaded boxes. The temporary deactivation in an upcoming time period can be indicated by the control information transmitted on the PHICH resources. A value of the control information indicated by “OFF” indicates that transmission on the second DL carrier 21 is deactivated in the upcoming time period TP. A value of the control information indicated by “ON” indicates that transmission on the second DL carrier 21 active in the upcoming time period TP. Such upcoming time period may for example be the next or a certain subsequent time period TP. The granularity of such time periods TP may be one or more subframes SF.

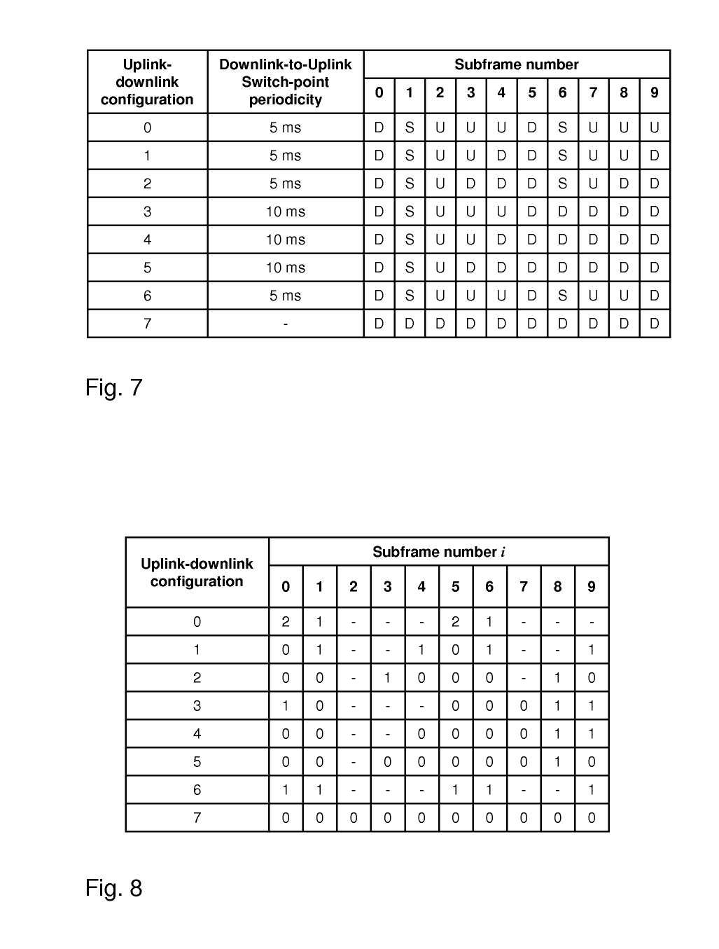

As mentioned above, the cellular network may also support configuration of a carrier as a TDD carrier. In the case of a TDD carrier, one or more of the subframes SF of a radio frame RF may be assigned to the DL direction and/or one or more of the subframes SF of a radio frame RF may be assigned to the UL direction. Further, one or more of the subframes SF of the radio frame RF may be assigned as special subframes. A table illustrating possible UL-DL configurations of the radio frames RF is shown in FIG. 7. In FIG. 7, “D” designates a subframe SF assigned to the DL direction, “U” designates a subframe SF assigned to the UL direction, and “S” designates a special subframe SF. The detailed structure of such subframes SF may be as described in 3GPP TS 36.211 V12.2.0.

As illustrated in FIG. 7, also a UL-DL configuration (referred to as “configuration #7”) is provided in which all the subframes SF of the radio frame RF are assigned to the DL direction (i.e., no subframe SF of the radio frame RF is assigned to the UL direction). As mentioned above, the second DL carrier 21 may also be configured as TDD carrier with all subframes assigned to the DL direction. Accordingly, the second DL carrier 21 may be configured as TDD carrier in UL-DL configuration #7. In such cases, the selection of between the first subconfiguration and the second subconfiguration may also be achieved by utilizing a corresponding predefined configuration of radio resources for transmission of the PHICH.

In accordance with section 6.9 of 3GPP TS 36.211 V12.2, a group of radio resources in which the PHICH is transmitted can be defined by mᵢ·N_{PHICH}^{group}, where mᵢ is a predefined value for each subframe SF. According to an embodiment, values of mᵢ as given by the table shown in FIG. 8 are utilized. As can be seen from the table of FIG. 8, for each of UL-DL configurations 1# to 6#, at least one of the subframes SF of the radio frame RF includes radio resources which are assigned to the PHICH. However, in the case of configuration #7, in which all subframes SF of the radio frame RF are assigned to the DL direction, the value mᵢ is zero for all the subframes SF, which means that in none of the subframes SF radio resources are configured for transmission of the PHICH.

Accordingly, the selection between the first subconfiguration and the second subconfiguration may also be indicated implicitly by the configuration of the second DL carrier 21.

As further possibilities, the selection between the first subconfiguration and the second subconfiguration may also be explicitly indicated in DL control signaling from the cellular network, e.g., corresponding control information could be broadcast in an MIB or in an SIB. Still further, corresponding control information could be included in an RRC message or L2/L1 signaling.

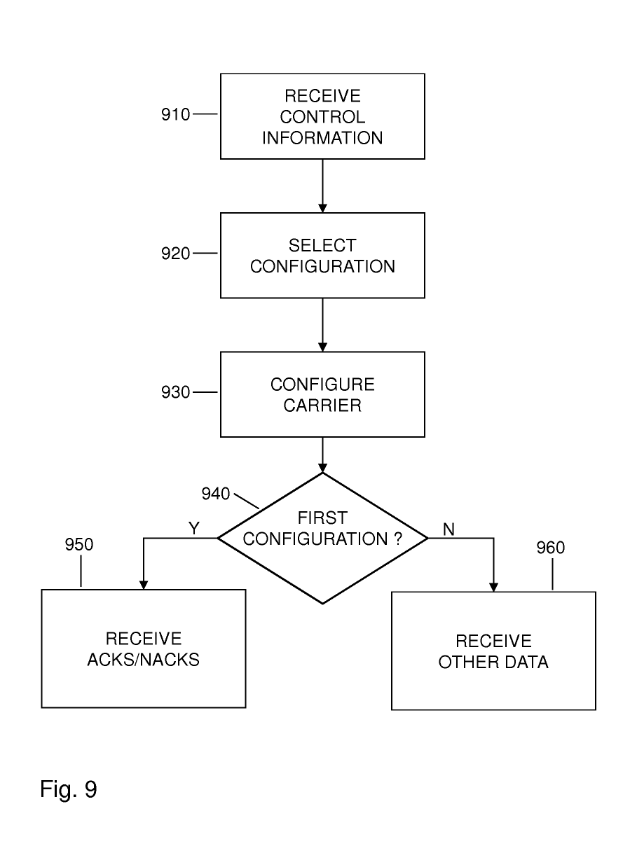

FIG. 9 shows a flowchart for illustrating a method which may be used for implementing the concepts as outlined above in a communication device, e.g., in the UE 100. If a processor based implementation of the communication device is used, the steps of the method may be performed by a processor of the communication device. For this purpose, the processor may execute correspondingly configured program code. In the method, it is assumed that the communication device is operated in a cellular network, e.g., based on the LTE technology.

At step 910, the communication device may receive control information. The control information may for example indicate a configuration of a carrier to be utilized by the communication device for communication with the cellular network, e.g., an FDD configuration or a TDD configuration with a certain UL-DL configuration. The configuration defines radio resources which are reserved for transmission of acknowledgements concerning UL transmissions from the communication device to the cellular network. Transmission on the carrier may be organized in radio frames which each are subdivided into subframes, e.g., as illustrated in FIG. 2. The configuration may for example indicate a TDD UL-DL configuration to be applied for one or more radio frames, i.e., specify one or more subframes of the radio frame which are assigned to the DL direction and/or one or more subframes of the radio frame which are assigned to the UL direction. Further, the control information may explicitly or implicitly indicate a subconfiguration with respect to the transmission of acknowledgements concerning UL transmissions from the communication device to the cellular network. In particular, the control information may indicate whether a first subconfiguration shall be applied, in which the reserved radio resources are configured for said transmission of acknowledgements concerning UL transmissions, or a second subconfiguration shall be applied, in which the reserved radio resources are not configured for said transmission of acknowledgements concerning UL transmissions. If the cellular network is based on the LTE technology, the reserved radio resources may be radio resources of a PHICH. The control information of step 910 may be broadcast in an MIB or an SIB, conveyed in an RRC message, or be indicated as part of L2/L1 signaling.

At step 920, the communication device selects between the first subconfiguration and the second subconfiguration. This may be accomplished depending on the control information received at step 910. Further, this selection may also depend on an deactivation or activation of a carrier on which the UL transmissions are performed. For example, in a carrier aggregation scenario, such as illustrated in FIG. 4, the UL transmissions may be on a further carrier which is temporarily deactivated. When the further carrier is active, i.e., used for performing UL transmissions, the communication device may select the first subconfiguration. When the further carrier is inactive, i.e., not used for performing UL transmissions, the communication device may select the second subconfiguration.

At step 930, the communication device configures the carrier. This may include configuring the carrier as an FDD carrier or as a TDD carrier. If the carrier is configured as a TDD carrier, the configuration of step 930 may also involve assigning one or more subframes of the radio frame to the DL direction and/or assigning one or more subframes of the radio frame to the UL direction. In some scenarios, all subframes of the radio frame may be assigned to the DL direction, as in the UL-DL configuration #7 of FIG. 7. Further, the reserved radio resources may be configured for said transmission of acknowledgements concerning UL transmissions, i.e., according to the above-mentioned first subconfiguration, or not configured for said transmission of acknowledgements concerning UL transmissions, i.e., according to the above-mentioned second subconfiguration. When utilizing the LTE technology, this may correspond to selecting between configuring a PHICH on the carrier and configuring no PHICH on the carrier. The configuration of step 930 may depend on the control information received at step 910 and on the selection performed at step 920.

At step 940, the communication device may check if the first configuration was selected. If this is the case, the method continues with step 950, as indicated by branch “Y”. If this is not the case, the method continues with step 950, as indicated by branch “N”.

At step 950, the communication device may utilize the reserved radio resources configured on the carrier for receiving positive or negative acknowledgements concerning the UL transmissions.

At step 960, the communication device may utilize the reserved radio resources configured on the carrier for receiving other data than acknowledgements concerning the UL transmissions. For example, such other data may include control information from the cellular network. The control information may for example indicate whether the carrier is served by a small cell in a dense small cell deployment or in a sparse small cell deployment, such as explained in connection with FIG. 5. The control information could also indicate deactivation or activation of transmission on the carrier in an upcoming time period, such as explained in connection with FIG. 6.

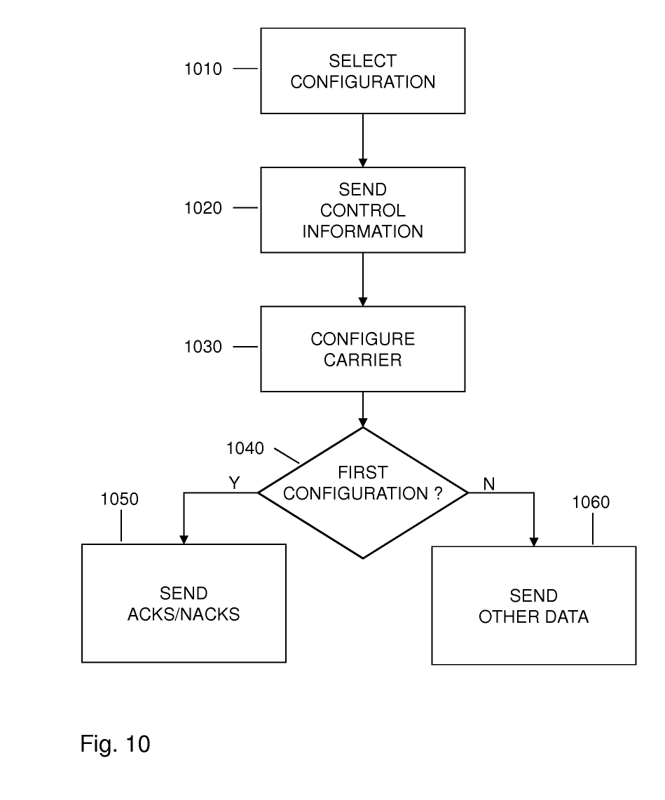

FIG. 10 shows a flowchart for illustrating a method which may be used for implementing the concepts as outlined above in a node of a cellular network, e.g., in a base station such as the eNB 200. If a processor based implementation of the node is used, the steps of the method may be performed by a processor of the node. For this purpose, the processor may execute correspondingly configured program code.

At step 1010, the node selects a configuration of a carrier for communication with a communication device, such as the UE 100. The configuration may define the carrier as an FDD or as a TDD carrier. The configuration defines radio resources which are reserved for transmission of acknowledgements concerning UL transmissions from the communication device to the cellular network. Transmission on the carrier may be organized in radio frames which each are subdivided into subframes, e.g., as illustrated in FIG. 2. In the case of a TDD carrier, the configuration may for example indicate an UL-DL configuration, i.e., specify one or more subframes of a radio frame which are assigned to the DL direction and/or one or more subframes of the radio frame which are assigned to the UL direction. Further, the configuration may relate to said transmission of acknowledgements concerning UL transmissions from the communication device to the cellular network. In particular, the configuration may distinguish between a first subconfiguration, in which the reserved radio resources are configured for said transmission of acknowledgements concerning UL transmissions, or a second subconfiguration, in which is the reserved radio resources are not configured for said transmission of acknowledgements concerning UL transmissions. If the cellular network is based on the LTE technology, in the first subconfiguration the reserved radio resources may be configured for transmission of a PHICH. In the second configuration the reserved radio resources may be utilized for other purposes. At step 1010, the node may select between the first subconfiguration and the subsecond configuration.

At step 1020, the node may send control information. The control information may explicitly or implicitly indicate the selected configuration of the carrier and/or the selected subconfiguration. The control information of step 1020 may be broadcast in an MIB or an SIB, conveyed in an RRC message, or be indicated as part of L2/L1 signaling.

At step 1030, the node configures the carrier. This may include configuring the carrier as an FDD carrier or as a TDD carrier. If the carrier is configured as a TDD carrier, the configuration may involve assigning one or more subframes of the radio frame to the DL direction and/or assigning one or more subframes of the radio frame to the UL direction. In some scenarios, all subframes of the radio frame may be assigned to the DL direction, as in the UL-DL configuration #7 of FIG. 7. Further, the reserved radio resources may be configured for said transmission of acknowledgements concerning UL transmissions, i.e., according to the abovementioned first subconfiguration, or not configured for said transmission of acknowledgements concerning UL transmissions, i.e., according to the above-mentioned second subconfiguration. When utilizing the LTE technology, this may correspond to selecting between configuring a PH ICH on the carrier and configuring no PHICH on the carrier. The configuration of step 1030 may depend on the selection performed at step 1010.

At step 1040, the node may check if the first configuration was selected. If this is the case, the method continues with step 1050, as indicated by branch “Y”. If this is not the case, the method continues with step 1050, as indicated by branch “N”.

At step 1050, the node may utilize the reserved radio resources configured on the carrier for sending positive or negative acknowledgements concerning the UL transmissions.

At step 1060, the node may utilize the reserved radio resources configured on the carrier for sending other data than acknowledgements concerning the UL transmissions. For example, such other data may include control information from the cellular network. The control information may for example indicate whether the carrier is served by a small cell in a dense small cell deployment or in a sparse small cell deployment, such as explained in connection with FIG. 5. The control information could also indicate deactivation or activation of transmission on the carrier in an upcoming time period, such as explained in connection with FIG. 6.

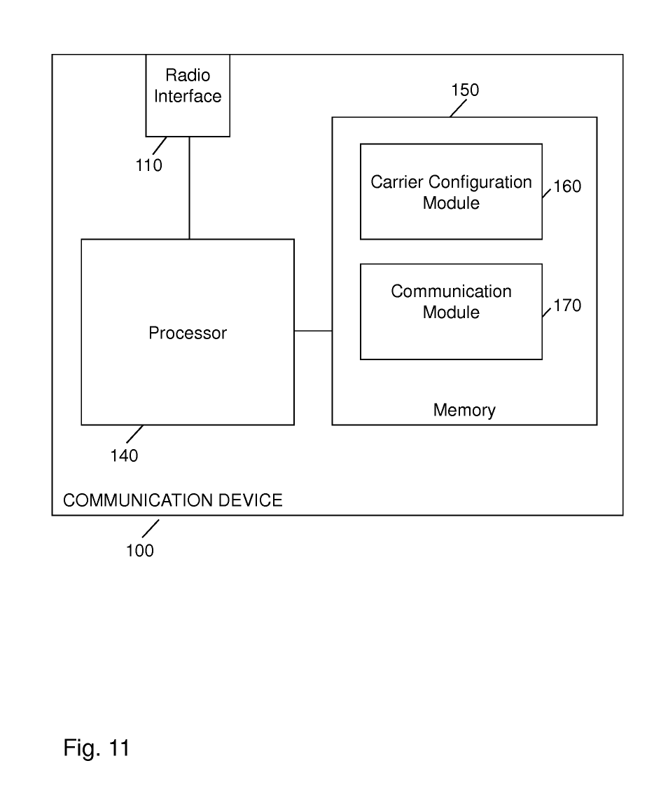

FIG. 11 schematically illustrates exemplary structures of a communication device which may be used for implementing the above-described concepts. For example, the structures illustrated in FIG. 11 may be used for implementing the UE 100.

As illustrated, the communication device includes a radio interface 110. The radio interface 110 may be configured to provide connectivity based on a cellular radio technology, such as the above-mentioned LTE technology. Further, the communication device includes a processor 140 coupled to the radio interface 110 and a memory 150 coupled to the processor 140.

The memory 150 includes program code modules 160, 170 with program code to be executed by the processor 140. In the illustrated example, these program code modules include a carrier configuration module 160 and a communication module 170.

The carrier configuration module 160 may include program code for implementing functionalities for selecting a configuration of a carrier, and functionalities for configuring the carrier according to the selected configuration. This may for example involve selecting between the first subconfiguration, in which the reserved radio resources are configured for the transmission of acknowledgements concerning UL transmissions, and the second subconfiguration in the reserved radio resources are not configured for the transmission of acknowledgements concerning UL transmissions.

The communication module 170 may include program code for implementing functionalities for performing communication with the cellular network. This may involve sending or receiving data on the carrier and/or on other carriers. This may also involve receiving control information from the cellular network.

In combination, the carrier configuration module 160 and the communication module 170 may implement functionalities corresponding to the steps of the method of FIG. 9.

It is to be understood that the structures as illustrated in FIG. 11 are merely exemplary and that the communication device may also include other elements which have not been illustrated, e.g., structures or program code modules for implementing known functionalities of a UE, such as a user interface or other communication functionalities. Also, it is to be understood that the detailed implementation of the illustrated structures may vary. For example, the memory 150 may include a read-only-memory (ROM), a random-access memory (RAM), a flash memory, magnetic storage, or the like.

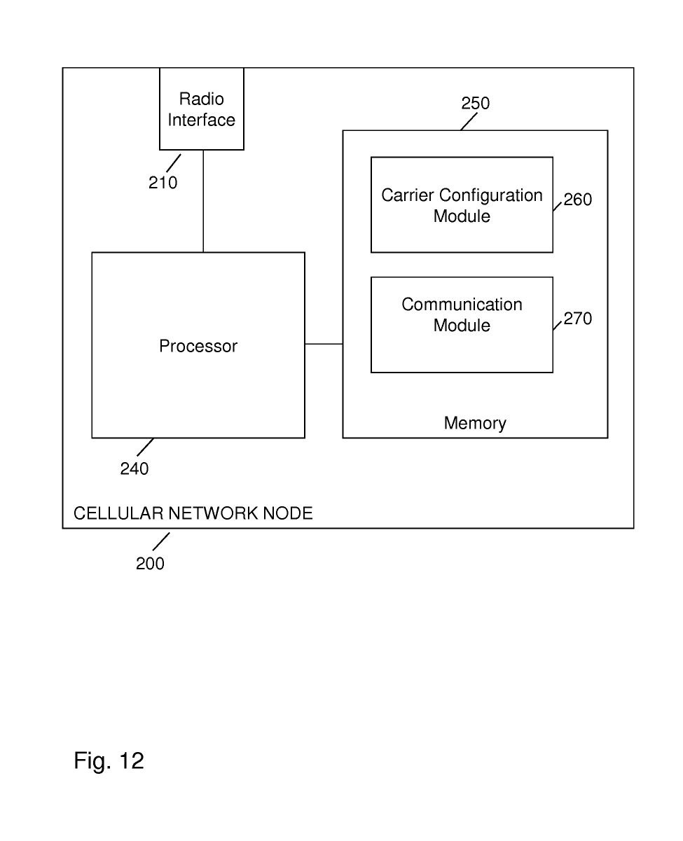

FIG. 12 schematically illustrates exemplary structures of a cellular network node which may be used for implementing the above-described concepts. For example, the structures illustrated in FIG. 12 may be used for implementing a base station, such as the eNB 200.

As illustrated, the node includes a radio interface 210. The radio interface 210 may be configured to support communication with one or more communication devices, such as the UE 100. Further, the node includes a processor 240 coupled to the radio interface 210 and a memory 250 coupled to the processor 240.

The memory 250 includes program code modules 260, 270 with program code to be executed by the processor 240. In the illustrated example, these program code modules include a carrier configuration module 260 and a communication module 270.

The carrier configuration module 260 may include program code for implementing functionalities for selecting a configuration of a carrier, and functionalities for configuring the carrier according to the selected configuration. This may for example involve selecting between the first subconfiguration, in which the reserved radio resources are configured for the transmission of acknowledgements concerning UL transmissions, and the second subconfiguration, in which the reserved radio resources are not configured for the transmission of acknowledgements concerning UL transmissions.

The communication module 270 may include program code for implementing functionalities for performing communication with the cellular network. This may involve sending or receiving data on the carrier and/or on other carriers. This may also involve receiving control information from the cellular network.

In combination, the carrier configuration module 260 and the communication module 270 may implement functionalities corresponding to the steps of the method of FIG. 10.

It is to be understood that the structures as illustrated in FIG. 12 are merely exemplary and that the cellular network node may also include other elements which have not been illustrated, e.g., structures or program code modules for implementing known functionalities of a base station, such as an eNB. Also, it is to be understood that the detailed implementation of the illustrated structures may vary. For example, the memory 150 may include a ROM, a RAM, a flash memory, magnetic storage, or the like.

As can be seen, the above-described concepts allow for efficiently managing utilization of a carrier in a cellular network. In particular, the concepts allow for flexible re-usage of certain radio resources of the carrier which are typically utilized for transmission of acknowledgements concerning UL transmissions.

It is to be understood that the concepts as explained above are susceptible to various modifications. For example, the concepts may be applied to various cellular radio technologies.

1. A method of controlling communication in a cellular network, the method comprising:
a communication device configuring a carrier for communication with the cellular network;
the communication device selecting a configuration of the carrier, the configuration defining radio resources which are reserved for transmission of acknowledgements concerning uplink transmissions from the communication device to the cellular network; and
the communication device selecting between:
a first subconfiguration in which the reserved radio resources are configured for said transmission of acknowledgements concerning uplink transmissions, and
a second subconfiguration in which the reserved radio resources are not configured for said transmission of acknowledgements concerning uplink transmissions.

2. The method according to claim 1,
wherein the uplink transmissions are on a further carrier.

3. The method according to claim 2,
wherein the further carrier is in an unlicensed frequency band.

4. The method according to claim 2,
wherein said selecting between the first subconfiguration and the second subconfiguration is performed depending on activation or deactivation of the uplink transmissions on the further carrier.

5. The method according to claim 2,
in response to the uplink transmissions on the further carrier being deactivated, the communication device selecting the second subconfiguration.

6. The method according to claim 2, comprising:
in response to the uplink transmissions on the further carrier being activated, the communication device selecting the first subconfiguration.

7. The method according to claim 1,
wherein the carrier is a time-division duplex carrier and transmission on the carrier is organized in radio frames which are each subdivided to subframes, and
wherein the configuration of the carrier defines, for each radio frame, one or more of the subframes which are assigned to a downlink direction from the cellular network to the communication device and/or one or more of the subframes which are assigned to an uplink direction from the communication device to the cellular network.

8. The method according to claim 7, comprising:
in response to all subframes of the radio frame being assigned to the downlink direction, the communication device selecting the second subconfiguration.

9. The method according to claim 1, comprising:
the communication device receiving control information from the cellular network, and
depending on the control information, the communication device selecting the second subconfiguration.

10. The method according to claim 1,
wherein in the second subconfiguration the reserved radio resources are configured for transmission of other data than acknowledgements concerning uplink transmissions from the communication device to the cellular network.

11. The method according to claim 10,
wherein said other data comprise control information from the cellular network.

12. The method according to claim 11,
wherein said control information indicates activation or deactivation of transmission on the carrier in an upcoming time period.

13. The method according to claim 11,
wherein said cellular network comprises a macro cell and multiple small cells located within a coverage region of the macro cell, and
wherein said control information indicates whether a coverage region of the small cell which serves the communication on the carrier has overlap with a coverage region of one or more others of the small cells.

14. A method of controlling communication in a cellular network, the method comprising:
a node of the cellular network configuring a carrier for communication with a communication device;
the node selecting a configuration of the carrier, the configuration defining radio resources which are reserved for transmission of acknowledgements concerning uplink transmissions from the communication device to the cellular network; and
the node selecting between:
a first subconfiguration in which the reserved radio resources are configured for said transmission of acknowledgements concerning uplink transmissions, and
a second subconfiguration in which the reserved radio resources are not configured for said transmission of acknowledgements concerning uplink transmissions.

15. The method according to claim 14,
wherein the uplink transmissions are on a further carrier.

16. The method according to claim 15,
wherein the further carrier is in an unlicensed frequency band.

17. The method according to claim 15,
wherein said selecting between the first subconfiguration and the second subconfiguration is performed depending on activation or deactivation of the uplink transmissions on further carrier.

18. The method according to claim 15,
in response to the uplink transmissions on the further carrier being deactivated, the node selecting the second subconfiguration.

19. The method according to claim 15, comprising:
in response to the uplink transmissions on the further carrier being activated, the node selecting the first subconfiguration.

20. The method according to claim 14,
wherein the carrier is a time-division duplex carrier and transmission on the carrier is organized in radio frames which are each subdivided to subframes, and
wherein the configuration of the carrier defines, for each radio frame, one or more of the subframes which are assigned to a downlink direction from the cellular network to the communication device and/or one or more of the subframes which are assigned to an uplink direction from the communication device to the cellular network.

21. The method according to claim 20, comprising:
in response to all subframes of the radio frame being assigned to the downlink direction, the node selecting the second subconfiguration.

22. The method according to claim 14, comprising:
the node sending control information to the communication device, the control information indicating the selected subconfiguration.

23. The method according to claim 14,
wherein in the second subconfiguration the reserved radio resources are configured for transmission of other data than acknowledgements concerning uplink transmissions from the communication device to the cellular network.

24. The method according to claim 23,
wherein said other data comprise control information from the cellular network.

25. The method according to claim 24,
wherein said control information indicates activation or deactivation of transmission on the carrier in an upcoming time period.

26. The method according to claim 24,
wherein said cellular network comprises a macro cell and multiple small cells located within a coverage region of the macro cell, and
wherein said control information indicates whether a coverage region of the small cell which serves the communication on the carrier has overlap with a coverage region of one or more others of the small cells.

27. A communication device, comprising:
a radio interface for connecting to a cellular network; and
a processor,
the processor being configured to:
configure a carrier for communication with the cellular network,
select a configuration of the carrier, the configuration defining radio resources which are reserved for transmission of acknowledgements concerning uplink transmissions from the communication device to the cellular network, and
select between:
a first subconfiguration in which the reserved radio resources are configured for said transmission of acknowledgements concerning uplink transmissions, and
a second subconfiguration in which the reserved radio resources are not configured for said transmission of acknowledgements concerning uplink transmissions.

28. A node for a cellular network, the node comprising:
a radio interface for connecting to a communication device; and
a processor,
the processor being configured to:
configure a carrier for communication with the communication device,
select a configuration of the carrier, the configuration defining radio resources which are reserved for transmission of acknowledgements concerning uplink transmissions from the communication device to the cellular network, and
select between:
a first subconfiguration in which the reserved radio resources are configured for said transmission of acknowledgements concerning uplink transmissions, and
a second subconfiguration in which the reserved radio resources are not configured for said transmission of acknowledgements concerning uplink transmissions.
